(19) United States
(12) Patent Application Publication
(10) Pub. No.: US 2018/0329023 A1
(43) Pub. Date: Nov. 15, 2018

(54) SYSTEM AND METHOD FOR WIRELESS TIME-OF-ARRIVAL LOCALIZATION

(71) Applicants: Fernando PEREZ-CRUZ, Hoboken, NJ (US); Howard HUANG, New York, NY (US); Chunhua GENG, Stirling, NJ (US)

(72) Inventors: Fernando PEREZ-CRUZ, Hoboken, NJ (US); Howard HUANG, New York, NY (US); Chunhua GENG, Stirling, NJ (US)

(21) Appl. No.: 15/591,672

(22) Filed: May 10, 2017

(51) Int. Cl. G01S 5/10; G01S 5/02

(52) U.S. Cl. CPC G01S 5/10; G01S 5/021; G01S 5/0278

(57) ABSTRACT

The method includes at least one processor estimating a first set of bias errors of a first set of base stations by obtaining a first set of time-of-arrival (ToA) measurements associated with the first set of base stations and a first set of devices, the first set of devices having known physical locations. The processor determines input parameters using the first set of bias errors, the input parameters including a first set of antenna locations for the first set of base stations, and a second set of ToA measurements associated with the first set of base stations and a first object, and determines a first object location for the first object using the input parameters.

### BACKGROUND OF THE INVENTION

### Field of the Invention

Example embodiments relate generally to a system and method for physically locating an object in a wireless network in order to control network traffic.

### Related Art

Being able to locate an object, such as a user device, a portable and/or electronic device, or a physical and/or an inanimate object (such as a delivery package, car keys, jewelry, vehicles, etc.), can save people time, effort, or help people and perform business tasks. Within the concept of the ‘internet of things,’ the act of locating a physical object may be accomplished via an inter-working of a communication network with the physical object that may be embedded (tagged) with electronics, sensors, actuators, or some other electronic structure allowing network connectivity that enables the object to communicate with the communication network.

In time-of-arrival (ToA) based localization, which may be used to locate an object in a wireless network, a number of synchronized transmitters may simultaneously transmit reference signals that may be received by the object to be localized. Subsequently, a time of arrival of the reference signals may be measured by the tagged object. In line-of-sight channels, the ToA may be converted directly to a ranging estimate using the speed of light. With additional knowledge of the location of the transmitters (which may be base stations), a multilateration algorithm may estimate the location of the object. Long term evolution (LTE) observed time difference of arrival (OTDOA) is an example of a ToA localization solution where an E-UTRAN Node B (eNBs) transmits reference signals known as position reference signals (PRSs). A user equipment (UE) may measure the ToA, and communicate these measurements back to a location server (more precisely, the UE may send time-difference-of-arrival measurements, known as TDoAs, by subtracting the ToA of an arbitrary reference). The ToA-based multilateration algorithm at a server may estimate the UE position.

Two impairments may limit the localization accuracy performance to about 100 m (at the 90%-ile). A first impairment may be an the error in the ToA measurement induced by non-line-of-sight (NLOS) reflections and multipath propagation. Due to these effects, there may be a positive bias in the ToA measurement compared to a LOS channel. The channel bias error may be up to several microseconds, caused for example by a reflected path which may travel hundreds of meters extra, compared to a direct LOS path. The channel bias may vary randomly with the multipath fading, at a rate given by the channel coherence time which may be a few hundred microseconds, for stationary UEs.

A second error may be caused by a miscalibration of the eNB. Two sources may contribute to this second error. A first source of error may be an incorrect location of the eNB transmit antenna, which, for example, could be the result of mistakenly surveying a position of the baseband processing unit (BBU) and which could be tens of meters away from the actual transmit antenna location. A second source of error may be caused by a miscalibration of the cable length between the antenna and the BBU, which may result in a fixed offset in the base station PRS transmission time, compared to a desired synchronized transmission time. Based on live network measurements, an eNB bias, characterized by the combination of the antenna position error and cable length calibration error, can be on the order of a hundred microseconds. In contrast to the channel bias, which is necessarily positive, the eNB bias error may be positive or negative. While the miscalibration of the eNB may be corrected by a site visit to the eNB by a field technician, this procedure is generally expensive and time-consuming.

In some known localization schemes, determination of non-line of sight (NLOS) bias may be estimated using an assumed NLOS bias distribution. Another known localization scheme assumes a sufficient number of eNBs (also known as “anchors”) can be line of sight with the tagged object that is being localized. Finally, yet another localization scheme uses multipath time and received signal strength measurements to estimate the bias.

### SUMMARY OF INVENTION

At least one example embodiment relates to a method of determining a location of an object.

In an embodiment, the method includes estimating, by at least one first processor of a network node, a first set of bias errors of a first set of base stations by obtaining a first set of time-of-arrival (ToA) measurements associated with the first set of base stations and a first set of devices, the first set of devices having known physical locations; determining, by the at least one first processor, input parameters using the first set of bias errors, the input parameters including a first set of antenna locations for the first set of base stations, and a second set of ToA measurements associated with the first set of base stations and a first object; and determining, by the at least one first processor, a first object location for the first object using the input parameters.

In an embodiment, the first set of TOA measurements includes a first TOA a second TOA respectively corresponding to a first base station and a second base station, of the first set of base stations, the estimating of the first set of bias errors further including, calculating a first time difference of arrival (TDoA) measurement for a first device, of the first set of devices, by subtracting the second ToA from the first ToA, and repeating the calculating step to determine a first set of TDoA measurements using pairings of additional TOA measurements from the first set of TOA measurements.

In an embodiment, the estimating of the first set of bias errors includes utilizing one of a gradient descent algorithm, a Metropolis Hastings sampling algorithm and an expectation propagation algorithm.

In an embodiment, the first set of bias errors includes a first set of antenna location bias errors and a first set of cable length bias errors associated with each base station of the first set of base stations.

In an embodiment, the determining of the input parameters includes, determining the second set of ToA measurements using the first set of cable length bias errors.

In an embodiment, the determining of the input parameters includes, determining the first set of antenna locations using the first set of antenna location bias errors.

In an embodiment, the determining of the first object location of the first object is accomplished without manually calibrating the first set of base stations to determine the first set of antenna locations.

In an embodiment, the determining of the first object location of the first object includes manually calibrating the first set of base stations to determine the first set of antenna locations.

In an embodiment, the determining of the first object location of the first object further includes, solving a numerical optimization problem using the input parameters, the numerical optimization problem including at least one of a Metropolis Hastings sampling algorithm and an expectation propagation algorithm.

At least another example embodiment relates to a network node.

In an embodiment, the network node includes a memory storing computer-readable instructions; and at least one processor configured to execute the computer-readable instructions such that the at least one processor is configured to, estimate a first set of bias errors of a first set of base stations by obtaining a first set of time-of-arrival (ToA) measurements associated with the first set of base stations and a first set of devices, the first set of devices having known physical locations, determine input parameters using the first set of bias errors, the input parameters including a first set of antenna locations for the first set of base stations, and a second set of ToA measurements associated with the first set of base stations and a first object, and determine a first object location for the first object using the input parameters.

In an embodiment, the first set of TOA measurements includes a first TOA a second TOA respectively corresponding to a first base station and a second base station, of the first set of base stations, the at least one processor being configured to estimate the first set of bias errors by, calculating a first time difference of arrival (TDoA) measurement for a first device, of the first set of devices, by subtracting the second ToA from the first ToA, and repeating the calculating step to determine a first set of TDoA measurements using pairings of additional TOA measurements from the first set of TOA measurements.

In an embodiment, the at least one processor is configured to estimate the first set of bias errors by utilizing one of a gradient descent algorithm, a Metropolis Hastings sampling algorithm and an expectation propagation algorithm.

In an embodiment, the first set of bias errors include a first set of antenna location bias errors and a first set of cable length bias errors associated with each base station of the first set of base stations.

In an embodiment, the at least one processor is configured to determine the input parameters by, determining the second set of ToA measurements using the first set of cable length bias errors.

In an embodiment, the at least one processor in configured to determine the input parameters by, determining the first set of antenna locations using the first set of antenna location bias errors.

In an embodiment, the at least one processor is configured to determine the first object location of the first object without a need to manually calibrate the first set of base stations to determine the first set of antenna locations.

In an embodiment, the at least one processor is configured to determine the first object location of the first object by first manually calibrating the first set of base stations to determine the first set of antenna locations.

In an embodiment, the at least one processor is configured to determine the first object location of the first object by, solving a numerical optimization problem using the input parameters, the numerical optimization problem including at least one of a Metropolis Hastings sampling algorithm and an expectation propagation algorithm.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 illustrates an E-UTRAN Node B (eNB) bias estimation system, in accordance with an example embodiment;

FIG. 2 illustrates an object location system for providing determination of NLOS bias distribution, in accordance with an example embodiment;

FIG. 3 schematically illustrates an embodiment of a device for performing some of the example method steps.

FIG. 4 illustrates a flowchart detailing a method of estimating the bias of an eNB 120 and correcting the inputs to a multilateration algorithm, in accordance with an example embodiment;

FIG. 5A depicts a histogram of the estimated ToA for a LOS channel, in accordance with an example embodiment;

FIG. 5B depicts a histogram of a NLOS channel where there is a strong reflected path which arrives after the first direct path, in accordance with an example embodiment;

FIG. 5C depicts the ToA measurements in a NLOS channel with unresolvable multipath, in accordance with an example embodiment;

FIG. 6 depicts a flow chart of a method to determine the physical location of tagged objects using a multilateration algorithm based on NLOS bias estimation; and

FIG. 7 illustrates an object location system using a NLOS bias distribution where the distribution may be non-zero Gaussian.

### DETAILED DESCRIPTION

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium, such as a non-transitory storage medium. A processor(s) may perform the necessary tasks.

Specific structural and functional details disclosed herein are merely representative for purposes of describing example embodiments. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be any non-transitory storage medium such as magnetic, optical, or flash memory, etc. Similarly, the transmission medium may be twisted wire pairs, coaxial cable, optical fiber, or some other suitable transmission medium known to the art. The example embodiments not limited by these aspects of any given implementation.

General Methodology:

A salient feature of the example embodiments relates to estimating a fixed bias error (a “bias”) of miscalibrated eNB parameters, where devices with “ground truth” (i.e., known physical locations) measure the time of arrival (ToA) of signals transmitted by the eNB, and the ToA measurements may be used to estimate the bias. This bias could consist of an error in the eNB antenna location and an error in the antenna cable length. Another salient feature of the example embodiments relates to correcting the inputs of a subsequent multilateration algorithm by canceling the effects of the estimated eNB bias from inputs. Another salient feature of the example embodiments relates to using the multilateration algorithm to determine the location of “tagged” objects. By estimating the bias of the eNB parameters and correcting the inputs to the multilateration algorithm, the method can improve the performance of the multilateration algorithm significantly. As another advantage, this method may be implemented without a need for manually calibrating the antenna location or cable length of the eNB, thereby offering a significant time and resource cost savings in determining a precise location and cable length of the eNB antenna while reducing (or, completely mitigating) the need for field technicians to manually calibrate the location and cable length of the eNB antenna, in order to allow the calibrated eNB to participate in precisely locating “tagged” objects.

Further example embodiments include a method for a multilateration algorithm that determines non-line of sight (NLOS) bias based on estimated NLOS bias distributions at a number of eNBs and the time of arrival (ToA) of a number of tag messages received at the eNBs. This can be accomplished, in part, by the methods disclosed in ‘Method and Apparatus for Determining Non-Line of Sight Bias Estimation,’ U.S. application Ser. No. 14/706,339, filed on May 7, 2015, the disclosure of which is incorporated by reference in its entirety. In particular, using eNB redundancy, objects that may be “tagged” (and existing in “tag locations”) may be estimated based on a NLOS bias distribution and the ToA, and then the tag locations may be used to update the NLOS bias distributions. The process of determining tag locations and updating the NLOS bias distributions may be repeated until the NLOS bias distributions converge.

Advantageously, a determination of the NLOS bias distributions may not require knowledge of actual tag locations, and therefore may be implemented with low overhead. Moreover, the determination may be tolerant to uncertainty, while providing 3D estimation, and providing improved reliability over other industry solutions. These example embodiments also may function in an indoor setting, and does not require a specific infrastructure, unlike well-known global positioning systems (GPS).

Example System Hierarchy:

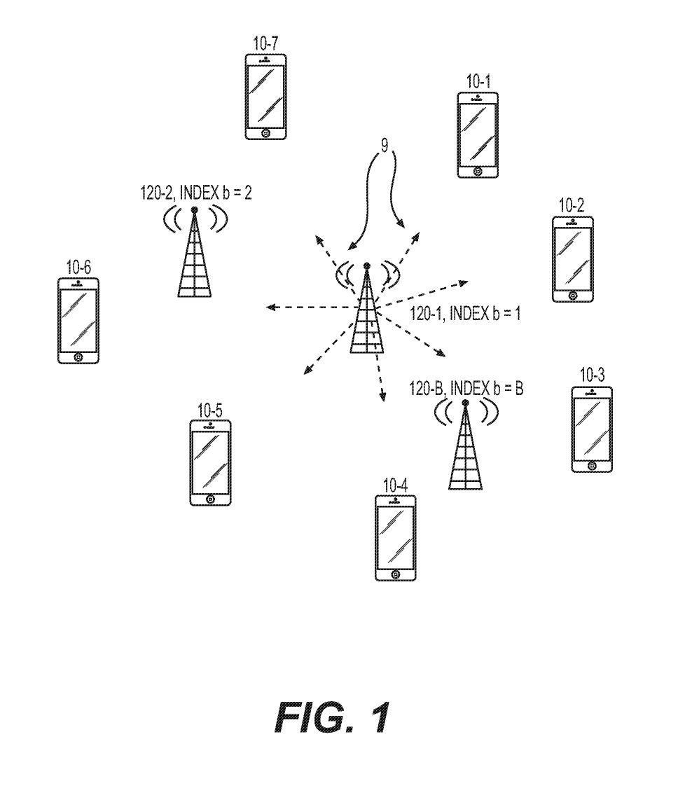

FIG. 1 illustrates an E-UTRAN Node B (eNB) bias estimation system 1, in accordance with an example embodiment. The system 1 may include one or more eNBs 120 and one or more sniffers 10 (described below in more detail). The eNBs 120 may include at least B devices (eNBs 120-1, 120-2, . . . , 120-B) whose biases are to be estimated. The sniffers 10 may include at least seven devices (sniffers 10-1, 10-2, 10-3, 10-4, 10-5, 10-6, 10-7) that may be used to estimate a bias for the antenna position and cable length parameters of eNBs 120, as described in detail in the method below. The signals emanating from each eNB 120 may represent transmitted reference signals 9 received by each of the sniffers. Each eNB may transmit a unique reference signal 9 associated with it.

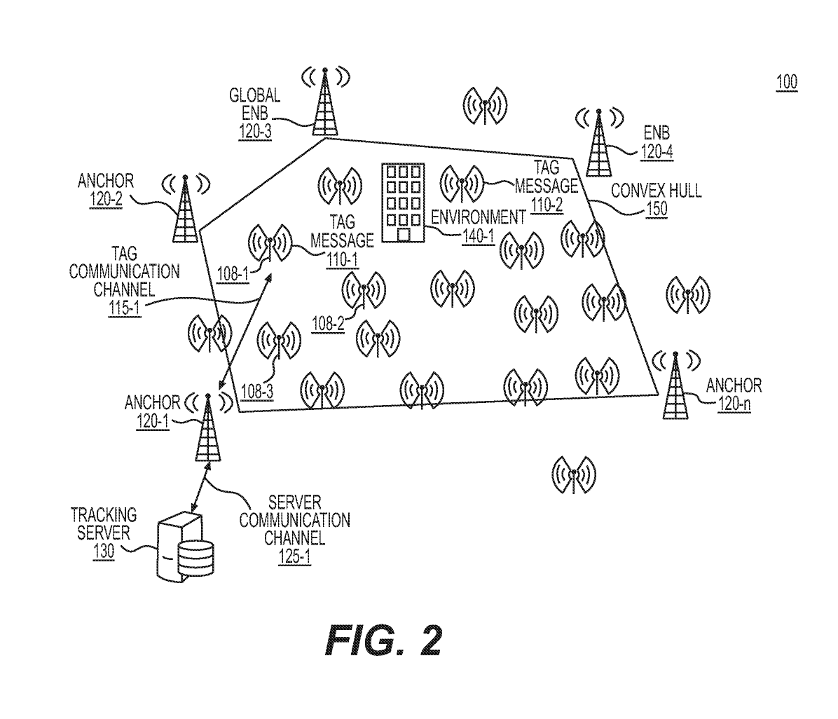

FIG. 2 illustrates an object (a “tagged” object) location system 100, in accordance with an example embodiment, where the system 100 may determine the location of the tagged object. The location system 100 may include an object 108 capable of transmitting tag messages 110, such as tag messages 110-1 and 110-2, where the messages 110 may be transmitted over a period of time to a plurality of eNBs 120, where the use of five or more eNBs 120-1-120-n (collectively, eNBs 120) is preferred. The tag messages 110 may be transmitted over tag communication channels 115, such as tag communication channel 115-1 (collectively referred to as tag communication channels 115). Tag communication channels 115 may be subject to environmental conditions, such as environment 140-1. The eNBs 120 may communicate with a tracking server 130 over one or more of server communication channels 125, such as server communication channel 125-1 (collectively referred to as server communication channels 125). For purposes of clarity, all of the tag messages 110 and eNBs 120 are not labeled. Furthermore, for purposes of clarity, all of tag communication channels 115 and server communication channels 125 are not illustrated.

“Tag” messages 110 may include any type of message delivered by a tag (or, a “tagged” object), over a period of time. A “tag” 108 may be any type of communication device capable of sending a wireless signal (e.g., the tag message 110) over one or more communication channels 115. One or more tag messages 110 may be delivered by the same tag 108 over a period of time. For example, tag message 110-1 may be delivered by the tag 108 at time (t), and tag message 110-2 may be delivered by the same tag 108 at time (t+1). The period of time may be any appropriate interval. It should be appreciated that while nineteen (19) tag messages are illustrated here, system 100 may include more tag messages. It should be appreciated that although described herein in the context of RF transmissions, a tag message may be any wave phenomena, including ultrasound waves or low-frequency sonar waves.

The eNB 120 may include an an E-UTRAN Node B (eNBs), another type of base station, a network node, or any other type of transmitter or communication device capable of receiving tag messages 110 over tag communication channels 115, in order to determine a time of arrival (ToA) of the tag message, where the eNB 120 may transmit the ToA information and information identifying the tag message to a server 130 via an appropriate one of server communication channels 125. In particular, participating eNBs 120 may have stable clocks that may be synchronized with each other, or synchronized with tracking server 130. Information identifying the tag message may be any suitable information enabling the tracking server 130 to associate the ToA information with the corresponding tag message, such as: (i) an identifier of the tag, such as a tag id; (ii) an identifier of the tag message, such as a tag message id; and/or (iii) a timestamp. Instructions for a multilateration algorithm may reside in the server 130, where the instructions may be used to determine a location of the tagged object 108. While the system in FIG. 2 depicts an uplink system, where the tagged object 108 may transmit a signal 115 which may be received by the synchronized eNBs 120, the system 100 may also implement a downlink system, where the tagged object 108 may receive multiple signals (not shown) transmitted by synchronized eNBs 120. This is due to the mathematical equivalence of the downlink and uplink measurements for multilateration. The downlink system 100 (depicted for FIG. 2) is consistent with the description of the downlink system depicted in FIG. 1. It should be understood that the system 100 of FIG. 1 for estimating the eNB biases may be implemented in the uplink direction, as well.

A number of eNBs 120 in the system of FIG. 1 is designated as being equal to B, where B may be an integer that is greater than 1. In an embodiment, the system of FIG. 1 may require ToAs measured by at least four eNBs 120, in order to determine the 3-dimensional coordinates of a tagged device using multilateriation. Moreover, the number of eNBs 120 at any one time may be dynamic, as eNBs 120 may be added or subtracted from the system of FIG. 1 at various times during operation.

Tag communication channels 115 may be any suitable wireless connection capable of propagating tag messages 110 generated by the tag 108-1 to one or more of eNBs 120, where the channel 115 may use radio frequency, ultrasonic, or visible light signals, for example. It should be appreciated that although depicted as a single connection, communication channels 115 may be any number or combinations of communication channels.

Server communication channels 125 may support communicating over one or more of the communication channels 125-1, where the channels 125 may utilize: wireless communications (e.g., LTE, GSM, CDMA, Bluetooth); WLAN communications (e.g., WiFi); packet network communications (e.g., IP); broadband communications (e.g., DOCSIS and DSL); storage communications (e.g., Fibre Channel, iSCSI), etc. It should be appreciated that although depicted as a single connection, communication channels 125 may be any number or combinations of communication channels.

Tracking server 130 may be any apparatus capable of communicating over one or more appropriate server communication channels 125, where the server 130 may determine an eNB 120 bias and calculate a NLOS bias distribution in order to locate one or more of tags 108 based on the communication channel message(s) 125 received from one or more eNBS 120. In particular, tracking server 130 may determine a NLOS bias estimation for each of eNBs 120, based on estimated NLOS bias distributions and ToA of a number of tag messages 110 received at the eNBs 120, by determining locations of tags 108 corresponding to the tag messages 110 using the NLOS bias distributions and the ToAs, where the location of tag 108 may be used to update the NLOS bias distributions. The process of determining tag locations and updating the NLOS bias distributions may be repeated until the NLOS bias distributions converge. It should be appreciated that while only one tracking server 130 is illustrated here, system 100 may include more tracking servers 130. It should be further appreciated that although depicted as communicating with eNBs 120 via server communication channels 125, tracking server 130 may communicate with eNBs 120 through any suitable communication network, or the server 130 may reside within the eNB 120.

The tag message environment may include one or more environmental conditions 140-1 that impact a direct line of sight between a tag 108 transmitting a tag message 110 and the eNB 120 that is receiving the tag message 120. Environmental conditions may be any suitable condition, such as: (i) buildings; (ii) office furniture; (iii) walls; (iv) vegetation (e.g., trees); and/or (v) vehicles, etc.

In some embodiments, tag messages 110 may be within a convex hull (e.g., convex hull 150) defined by the participating eNB 120. It should be appreciated that, by constraining tag messages 110 within the convex hull 150 defined by the eNB 120, performance may be improved as the eNB 120 may be advantageously and/or equidistantly placed, and environmental conditions 140 may therefore be better tracked or controlled. In some of these embodiments, the eNB 120 may be placed within an establishment, such as a building, a store, or an office space, etc.

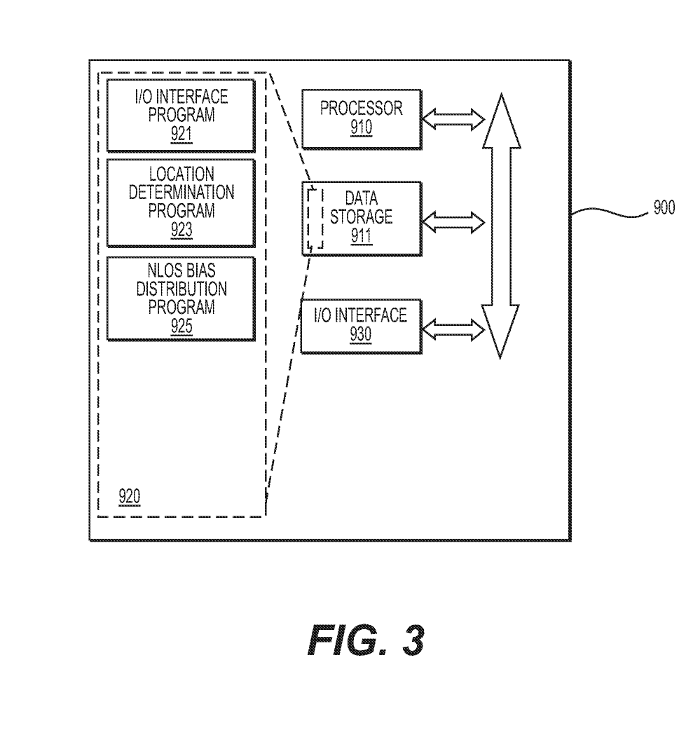

FIG. 3 schematically illustrates an embodiment of a device 900, where the device 900 may be the eNB 120/320, or the tracking server 130. The device 900 may include a processor 910, data storage 911, and I/O interface 930. The memory storage 911 may include the instructions of the method steps and algorithms described below, where the processor 910 may control operations of the device 900 and execute the method steps of the example methods described herein. That is to say, the processor 910 may cooperate with the data storage 911. The data storage 911 may also optionally store program data such as NLOS bias distributions, ToA values, or the like, as appropriate.

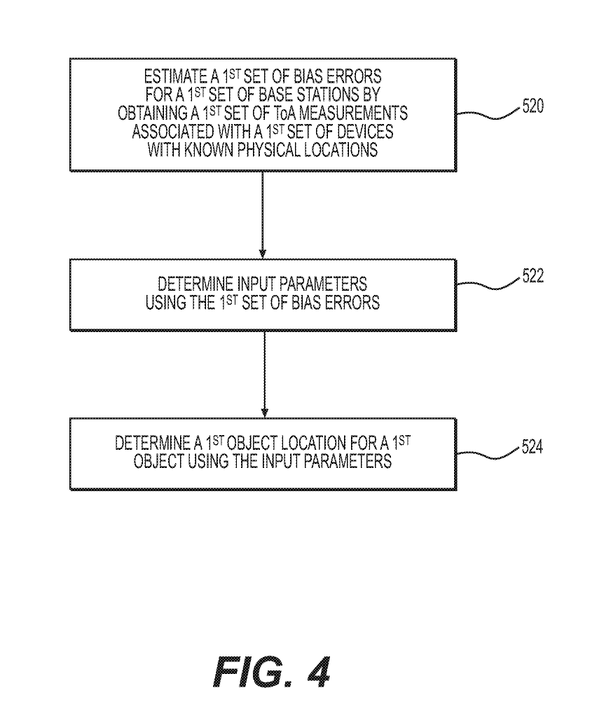

The processor-executable programs 920 may include an I/O interface program 921, a location determination program 923 (which may include the method of FIGS. 4 and/or 6, for instance), or a NLOS bias distribution program 925. Processor 910 may cooperate with processor-executable programs 920.

The I/O interface 930 may cooperate with processor 910 and I/O interface program 921 to support communications over communication channels 115 or 125 (of FIG. 2) as appropriate and as described above.

The NLOS bias distribution program 925 may be saved in the data storage 911, where the processor 910 may be configured to perform the method steps of FIG. 8 (described below).

In some embodiments, the processor 910 may include resources such as processors/CPU cores, the I/O interface 930 may include any suitable network interfaces, or the data storage 911 may include memory or storage devices. Moreover the device 900 may be a physical hardware configuration such as: one or more server(s), blades consisting of components such as processor, memory, network interfaces or storage devices. In some of these embodiments, the device 900 may include cloud network resources that are remote from each other.

In an embodiment, the device 900 may be a virtual machine. In some of these embodiments, the virtual machine may include components from different machines or be geographically dispersed. For example, the data storage 911 and the processor 910 may be in two different physical machines.

When processor-executable programs 920 (saved in data storage 911) are implemented on a processor 910, the program code segments combine with the processor 910 to provide a unique device 900 that operates analogously to specific logic circuits.

### Specific Example Methodology

FIG. 4 illustrates a flowchart detailing a method of estimating a bias in order to correct input variables of a multilateration algorithm for the eNB 120, where the multilateration algorithm may be used to locate tagged objects 108, in an example embodiment. The steps of the method, described herein, may be saved as instructions in data storage 911, where a processor 910 (FIG. 3) may perform these method steps. The processor 910 may reside, for instance, in an eNB 120 or a tracking server 130. In particular, the method may include two major steps, where the first step generally may involve estimating a fixed error bias of miscalibrated eNB parameters (or “estimating the eNB biases”), and the second step generally may involve using estimated eNB biases to correct input variables of a multilateration algorithm (or “correcting inputs of the multilateration algorithm”). Both of these steps are described below, in conjunction with the flowchart shown in FIG. 4.

Estimating the eNB biases:

The biases for given eNBs 120 (FIG. 1) with index b may be estimated using measurements from devices 10 with a known “ground truth” location, where the devices 10 may be referred to as “sniffers.” This example method presumes that the sniffers 10 may be unsynchronized, as it may be expensive or impractical to guarantee synchronization of the sniffers 10, due to the manual effort that may be involved in conducting a synchronization process. The sniffer 10 may be embodied as a dedicated stand-alone device, a mobile device, a server, a network node, a mobile phone, etc., as described below in more detail. For base b=1, . . . , B, p_{b} may denote an antenna position error, and c_{b} may denote a cable calibration error. A LOS channel may be assumed between the eNB 120 with estimated location coordinates x_{b} (3-dimensional vector) and the sniffer 10 with index s with a known ground truth location denoted as xₛ (3-dimensional vector). The time of arrival of a reference signal transmitted from eNB 120 with index b and received at sniffer 10 may be written as follows.

t_{b,s}=∥xₛ−(x_{b}−p_{b})∥/q+τ+c_{b}+n_{b} (Eq. 1)

In this equation, the speed of light may be denoted as q, and τ may be an unknown transmit time referenced to a clock at eNB b, and n_{b} may be an additive Gaussian noise characterizing the ToA estimation error with zero mean and variance may be given by a Cramer-Rao lower bound which we denote as σ². Because the eNBs 120 may be synchronized and because the reference signals may be transmitted simultaneously from each eNB, the transmit time τ is common for each eNB in Eq. 1. However, the transmit time τ is unknown at the sniffer receiver because the sniffer may be assumed to be unsynchronized with respect to the eNBs 120.

To eliminate the unknown transmit time, a time difference of arrival (TDoA) may be determined from the two ToA measurements, using the ToA measurement from eNB 120 with index b=1 as the reference:

$$\underline{Δ {t}_{b 1 , s} =} {t}_{b , s} \underline{-} {t}_{1 , s} = [ ‖ {x}_{s} - ( {x}_{b} - {p}_{b} ) ‖ - ‖ {x}_{s} - ( {x}_{1} - {p}_{1} ) ‖ ] / q + ( {c}_{b} - {c}_{1} ) + ( {n}_{b} - {n}_{1} ) \qquad ( Eq . 1 b )$$

The initial (uncorrected) locations of eNB 120 x_{b} (b=1, . . . , B) and ground truth location of sniffer 10 xₛ may be known. There may be a total of 7 unknowns in this equation 1b, consisting of the 3 coordinate values of antenna 1 position error p₁ (for the x, y, and z dimensions), the 3 coordinate values of antenna b position error p_{b}, and the unknown cable calibration error difference cₘ≙c_{b}−c₁. The coordinate values p₁, p_{b} and cable calibration error cₘ can be estimated by solving the following maximum a posteriori (MAP) estimation problem:

(\hat{p}_{b},\hat{p}₁,ĉ_{b1})=arg maxₚ_{_{b}}_{,p}_{₁}_{,c}_{_{b1}}[Πᵢ₌₁^{S}p(Δt_{b1,s}|p_{b},p₁,c_{b1})]p(p_{b},p₁,c_{b1}), (Eq. 1c)

where the likelihood may follow a Gaussian distribution

p(Δt_{b1,s}|p_{b},p₁,c_{b1})˜η([∥xₛ−(x_{b}−p_{b})∥−|xₛ−(x₁−p₁)∥]/q+c_{b1},2σ²)

and the prior may be chosen as follows

$$p ( {p}_{b} , {p}_{1} , {c}_{b 1} ) = \frac{1}{( ‖ {p}_{b} ‖ + ɛ ) ( ‖ {p}_{1} ‖ + ɛ )} ,$$

where ε is a small positive constant chosen to prevent numerical instability in the prior.

Using ToA measurements from at least S=7 sniffers with locations which may be at different angles around the base (to provide favorable dilution of precision), the optimization problem in Eq. 1c may be solved to obtain the 7 unknowns using any known technique such as a gradient descent algorithm, expectation propagation, or Metropolis Hastings sampling.

For the more general case of a non line-of-sight channel, the measured ToA may refer to time at which a correlator output exceeds a threshold, as described in more detail below. Using any well-known method (such as the method described in ‘Method and Apparatus for Determining Non-Line of Sight Bias Estimation,’ U.S. application Ser. No. 14/706,339, filed on May 7, 2015, which is cited above and incorporated by reference in its entirety into this document), the eNB biases may be estimated by solving a generalization of Eq. 1c, which may incorporate a statistical characterization of the NLOS channel bias.

To implement this concept, as shown in step S20 of FIG. 4, the processor 910 may estimate bias errors for the set of eNBs 120 by obtaining ToA measurements from the sniffers 10, where the sniffers have a known “ground truth.”

Correcting Inputs of the Multilateration Algorithm:

For a device 108 (FIG. 2) to be located, a multilateration algorithm may be used to estimate its location, using as inputs the ToA estimates from multiple eNBs 120 along with known location information for the eNBs 120 (as described below). Therefore, to that end, in step S22 of FIG. 4, the processor 910 may use the estimated bias errors for the eNBs 120 to correct input variables (i.e., “input parameters”) for a multilateration algorithm. The input variables (“input parameters”) may include a set of antenna locations for the set of eNBs 120, along with a second set of ToA measurements (where the second set of ToA measurements may be associated with the first set of eNBs 120 and an object 108-1). In particular, for a signal transmitted by tagged device 108 with measured ToAs t_{b} at eNB 120 (b=1, . . . , B), the input to the multilateration algorithm may include the corrected ToA in which the cable bias may be removed: t_{b}−ĉ_{b1}. And given the estimated eNB 120 locations x_{b}, the input to the multilateration algorithm may include a corrected location in which the position bias may be removed: x_{b}−\hat{p}_{b}. Following step S22, then in step S24 the processor 910 may determine a location of the object 108-1 (see FIG. 2) using the input variables that may be utilized within any well-known multilateration algorithm. All well-known multilateration algorithms based on known deterministic techniques or probabilistic techniques may use the same inputs, so the cancellation of the bias effects may be applicable to them all. These techniques will be described in more detail below.

Structural Embodiments of the “Sniffer”:

Dedicated Sniffer:

The “sniffer” 10 may be implemented as a dedicated device mounted, for example, on a roof of a building, so that the sniffer 10 has near LOS channels with surrounding eNBs 120. Each sniffer may measure the ToAs of position reference signals (PRSs) from multiple eNBs 120 and communicate the TDoAs with respect to an arbitrary reference eNB back to the network. Hence the sniffer 10 may be a user equipment (UE) device. The sniffer 10 may also be powered using a solar panel and battery so it doesn't need to rely on wired power. The ground truth location of the sniffer 10 may be recorded during installation. Alternatively, the location of the sniffer 10 may be determined by treating it as a tagged device 108 to be located. Because the sniffer 10 may be stationary, the estimate of its location may be refined over time.

Crowdsourcing:

A condition for estimating the eNB bias is for the sniffer 10 with known ground truth to measure eNB ToAs. Therefore, a handset devices may use GPS to determine the ground truth (with some error). In emergency (e911) localization services, a handset typically reports GPS location. So, TDoA measurements from these handsets may be used to estimate the eNB biases. An existing e911 call log (which contain GPS location and TDoA measurements) may also be used to estimate the eNB biases.

Test Driving:

The sniffer 10 may be mobile. For example, the sniffer 10 may be mounted on a roof of a car, or located on a drone, just as an example. GPS may be used to provide the location ground truth.

Estimating eNB Bias for NLOS Channel:

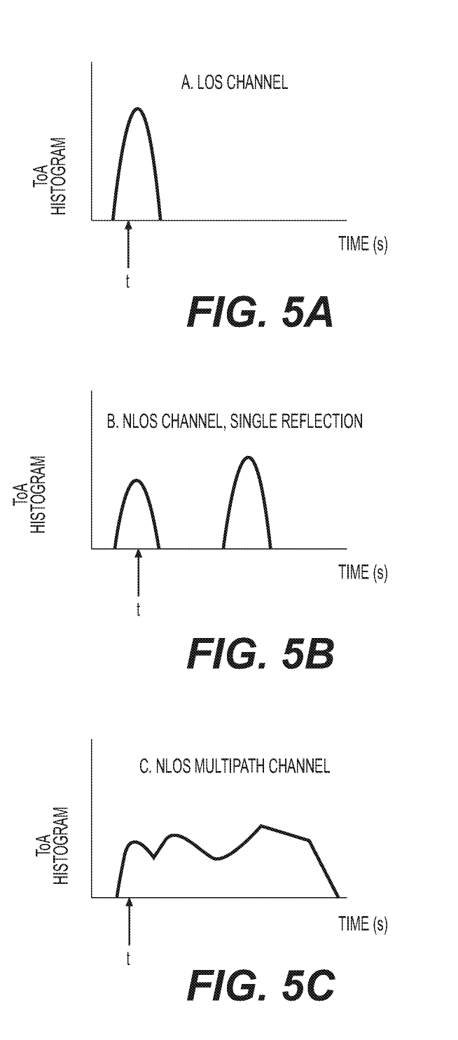

In general, the estimated ToAs t_{b,s} described above for estimating the eNB bias may be determined from multiple ToA measurements. As described above, in a LOS channel, the estimated ToA may be unbiased, and the variance may be determined by the Cramer-Rao Lower Bound. FIG. 5A depicts a histogram of the estimated ToA for a LOS channel, where the ToA t may be estimated by determining the mean of the measured ToAs. FIG. 5B depicts a histogram of a NLOS channel where there is a strong reflected path which arrives after the first direct path. Instead of determining the mean of all ToA measurements, the ToA estimate may be the mean of only those measurements corresponding to the first arrival. More generally, FIG. 5C depicts the ToA measurements in a NLOS channel with unresolvable multipath. The ToA estimate in this case may be the time where the number of ToA measurement samples exceed a threshold value.

Implementation in a Server:

An implementation for estimating and canceling the eNB bias may be to perform the operations at a tracking server 130 (a dedicated network server for this purpose), or at a central server. Alternatively, the bias estimation may be determined at the sniffer 10. In this scenario, the sniffer 10 may measure the ToAs and receive from the network the corrected base station locations x_{b}−\hat{p}_{b} (b=1, . . . , B) and the calibration errors ĉ_{b1} (b=1, . . . , B).

Using the Corrected Inputs in a Multilateration Algorithm for Locating Objects:

Once the eNB 120 bias parameters are estimated, we can use the estimates to correct the inputs for multilateration algorithm in order to locate objects, as further described herein.

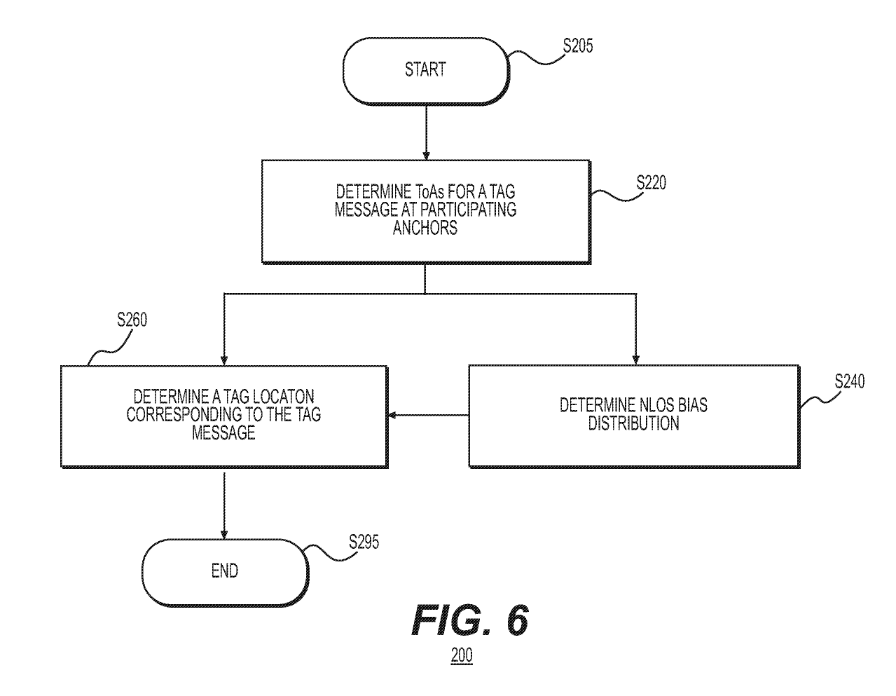

FIG. 6 depicts a flow chart illustrating an embodiment of a method 200 for a device (such as the tracking server 130, or the eNB 120, of FIG. 2) to determine a tagged objects 108 physical location based on NLOS bias estimation. The method may be an algorithm saved in the memory 911 (FIG. 3) of the device 120/130, where the processor 910 of the device 120/120 may perform these method steps. In step S205, the processor 910 may determine ToAs for a tag message 110 at calibrated eNBs 120 (step S220), and then determine an NLOS bias distribution (step S240), determine a tag 108 physical location corresponding to the tag message 110 (step S260), prior to ending the method at step S295.

In the method 200, the step S220 may include determining ToAs for the tag message 110 at the calibrated eNBs 120. In particular, a tag 108 may transmit a tag message 110 which may be received by five or more participating eNBs 120 (where each of the eNBs 120 may be calibrated with known physical locations for their antennas). Each of the participating eNBs 120 may estimate the ToA of the tag message 110 using a common time reference and transmits the ToA and optional attendant information to a tracking server 130. The tracking server 130 may determine the ToAs by retrieving the appropriate information from a messages 115 received from each of the eNBs 120. Optional attendant information may be any suitable information such as information associated with the tag message 110 as described herein, or information associated with the eNB 120 such as: (i) an identifier of the eNB 120 such as an eNB identifier or an IP address; and/or (ii) actual location information (such as GPS coordinates). Information associated with tag message 110 may enable the tracking server 130 to associate the ToA information with a particular tag message 110 and information associated with the eNB 120 may enable the tracking server 130 to associate the ToA with a particular eNB 120 or eNB 120 physical location.

In the method 200, the step S240 may include determining a NLOS bias distribution, as described herein.

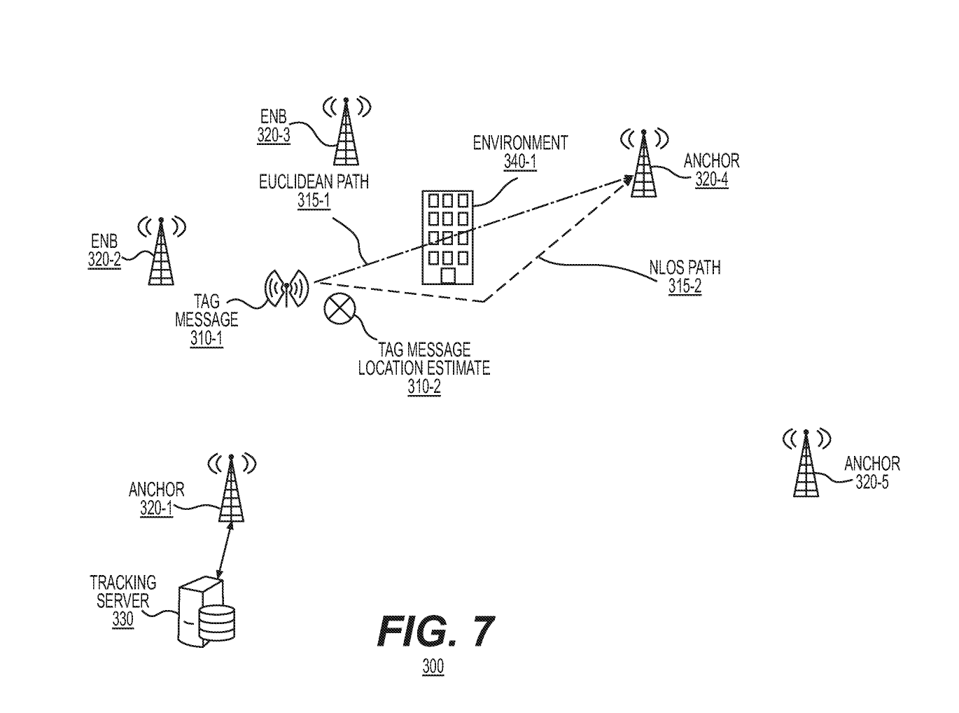

In the method 200, the step S260 may include determining a location of tag 108 corresponding to the tag message 110. In particular, the tag location may be determined based on the NLOS bias distribution for each of the participating eNBs 120 and the ToA received from each of the participating eNBs 120. In one embodiment, referring to FIG. 7, to linearize equations (2) and (3), the ToA of the tag message at five (5) or more eNBs 120 (e.g., eNBs 320-1-320-5) and the NLOS bias distribution at those participating eNBS 320 may be used to solve for x and t (3D localization) (e.g., providing tag message location estimate 310-2). In this embodiment, the distribution of n₁ is assumed to be a non-zero Gaussian.

t_{b}−τ=d_{b}/q+γ_{b}+n_{b}−ĉ_{b1} (Eq. 2)

d_{b}=\sqrt{∥x−(x_{b}−\hat{p}_{b})∥²} (Eq. 3)

Where t_{b} may be the ToA of the tag message at eNB b, r may be an unknown time that the tag message was transmitted by the tag, d_{b} may be a distance of the Euclidean path between the tag and the eNB 320 (e.g., Euclidean path 315-1 between tag message 310-1 and eNB 320-4), q may be the speed of light, and γ_{b} may be the NLOS bias between the tag and the eNB 320 (e.g., the added bias to travel NLOS path 315-2 as compared to LOS path 315-1 due to environment 340-1 being in the LOS path of tag message 310-1 and eNB 320-4).

The noise error (e.g., clock error and ToA estimation error) may be denoted as n_{b}, x may be an unknown location of the tag transmitting the tag message (e.g., tag message 310-1), and x_{b} may be a known location of the bth eNB 320 (e.g., location of eNB 320-1).

The cable calibration difference estimated between eNB b and the reference eNB 1 may be denoted as ĉ_{b1}, and the eNB b antenna location error may be denote as \hat{p}_{b}.

In some embodiments of the step S260, the tag location may be determined by solving the optimization problem in equation (4), shown below.

$$\hat{x} = {argmax}_{x , τ} p ( x ) {\prod }_{b = 1}^{N} \frac{{p}_{j} ( {t}_{b} \vert τ , {d}_{b} , {σ}_{n} , Parameters )}{{d}_{b}} \qquad ( Eq . 4 )$$

Where \hat{x} may be an estimated tag location, b may be an eNB index, N may be a number of participating eNBs.

\hat{p}_{b}(t_{b}|τ, d_{b}, σₙ, Parameters)

The NLOS bias distribution for the jth eNB based on the ToA of a tag message sent at time ti over the distance d₃ and standard deviation of σₙ with optional parameters may be denoted as p_{b}(t_{b}|τ, d_{b}, σₙ, Parameters), and d_{b} may be a distance of the Euclidean path between the tag and the eNBS 320 (e.g., Euclidean path 315-1 between tag message 310-1 and eNB 320-4).

In an embodiment, σₙ² (i.e., the variance) may instead be denoted as σₙ. In an embodiment, the parameters may be vectors for describing a mixture of Gaussians. In some of these embodiments, the parameters may be πⱼ, μⱼ, and Vⱼ.

In an embodiment, Equation 4 (described above) may be solved using well-known optimization algorithms based on gradient descent methods. Alternatively, the equation may be solved using well-known inference methods, such as Metropolis Hastings sampling or expectation propagation.

Improvements in reducing NLOS bias in a localization systems having six (6) eNBb (e.g., such as system 100 of FIG. 2) may achieve greater than three (3) times improvement in localization accuracy for LTE channel models.

It should be appreciated that steps of various above-described methods can be performed by the processor 910 of a stand-alone server 130, or an eNB 120/320, or another network node. The program storage 911 for the device (containing the processor 910) may be, for example, digital memories, magnetic storage media such as a magnetic disks and magnetic tapes, hard drives, or optically readable data storage media. The embodiments are also intended to cover special-purpose computers programmed to perform said steps of the above-described methods.

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

The description and drawings merely illustrate the principles of the example embodiments. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the example embodiments, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional or custom, may also be included.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A method of determining a location of an object, comprising:
estimating, by at least one first processor of a network node, a first set of bias errors of a first set of base stations by obtaining a first set of time-of-arrival (ToA) measurements associated with the first set of base stations and a first set of devices, the first set of devices having known physical locations;
determining, by the at least one first processor, input parameters using the first set of bias errors, the input parameters including a first set of antenna locations for the first set of base stations, and a second set of ToA measurements associated with the first set of base stations and a first object; and
determining, by the at least one first processor, a first object location for the first object using the input parameters.

2. The method of claim 1, wherein the first set of TOA measurements includes a first TOA a second TOA respectively corresponding to a first base station and a second base station, of the first set of base stations, the estimating of the first set of bias errors further including,
calculating a first time difference of arrival (TDoA) measurement for a first device, of the first set of devices, by subtracting the second ToA from the first ToA, and
repeating the calculating step to determine a first set of TDoA measurements using pairings of additional TOA measurements from the first set of TOA measurements.

3. The method of claim 2, wherein the estimating of the first set of bias errors includes utilizing one of a gradient descent algorithm, a Metropolis Hastings sampling algorithm and an expectation propagation algorithm.

4. The method of claim 1, wherein the first set of bias errors includes a first set of antenna location bias errors and a first set of cable length bias errors associated with each base station of the first set of base stations.

5. The method of claim 4, wherein the determining of the input parameters includes,
determining the second set of ToA measurements using the first set of cable length bias errors.

6. The method of claim 4, wherein the determining of the input parameters includes,
determining the first set of antenna locations using the first set of antenna location bias errors.

7. The method of claim 2, wherein the determining of the first object location of the first object is accomplished without manually calibrating the first set of base stations to determine the first set of antenna locations.

8. The method of claim 1, wherein the determining of the first object location of the first object includes manually calibrating the first set of base stations to determine the first set of antenna locations.

9. The method of claim 1, wherein the determining of the first object location of the first object further includes,
solving a numerical optimization problem using the input parameters, the numerical optimization problem including at least one of a Metropolis Hastings sampling algorithm and an expectation propagation algorithm.

10. A network node, comprising:
a memory storing computer-readable instructions; and
at least one processor configured to execute the computer-readable instructions such that the at least one processor is configured to,
estimate a first set of bias errors of a first set of base stations by obtaining a first set of time-of-arrival (ToA) measurements associated with the first set of base stations and a first set of devices, the first set of devices having known physical locations,
determine input parameters using the first set of bias errors, the input parameters including a first set of antenna locations for the first set of base stations, and a second set of ToA measurements associated with the first set of base stations and a first object, and
determine a first object location for the first object using the input parameters.

11. The network node of claim 10, wherein the first set of TOA measurements includes a first TOA a second TOA respectively corresponding to a first base station and a second base station, of the first set of base stations, the at least one processor being configured to estimate the first set of bias errors by,
calculating a first time difference of arrival (TDoA) measurement for a first device, of the first set of devices, by subtracting the second ToA from the first ToA, and
repeating the calculating step to determine a first set of TDoA measurements using pairings of additional TOA measurements from the first set of TOA measurements.

12. The network node of claim 11, wherein the at least one processor is configured to estimate the first set of bias errors by utilizing one of a gradient descent algorithm, a Metropolis Hastings sampling algorithm and an expectation propagation algorithm.

13. The network node of claim 10, wherein the first set of bias errors include a first set of antenna location bias errors and a first set of cable length bias errors associated with each base station of the first set of base stations.

14. The network node of claim 13, wherein the at least one processor is configured to determine the input parameters by,
determining the second set of ToA measurements using the first set of cable length bias errors.

15. The network node of claim 13, wherein the at least one processor in configured to determine the input parameters by,
determining the first set of antenna locations using the first set of antenna location bias errors.

16. The network node of claim 11, wherein the at least one processor is configured to determine the first object location of the first object without a need to manually calibrate the first set of base stations to determine the first set of antenna locations.

17. The network node of claim 10, wherein the at least one processor is configured to determine the first object location of the first object by first manually calibrating the first set of base stations to determine the first set of antenna locations.

18. The network node of claim 10, wherein the at least one processor is configured to determine the first object location of the first object by,
solving a numerical optimization problem using the input parameters, the numerical optimization problem including at least one of a Metropolis Hastings sampling algorithm and an expectation propagation algorithm.
